(19) United States
(12) Patent Application Publication
(10) Pub. No.: US 2026/0138508 A1
(43) Pub. Date: May 21, 2026

(54) ROTATIONAL CAR SEAT

(71) Applicant: MONAHAN PRODUCTS, LLC, Rockland, MA (US)

(72) Inventors: Anthony P. Sandonato, Abington, MA (US); Scott Anderson, Narvon, PA (US); Cody Campbell, Rockland, MA (US); Joseph Cooper, South Boston, MA (US)

(21) Appl. No.: 19/389,806

(22) Filed: Nov. 14, 2025

Related U.S. Application Data
(60) Provisional application No. 63/721,165, filed on Nov. 15, 2024.
(60) Provisional application No. 63/892,292, filed on Oct. 2, 2025.

(51) Int. Cl. B60N 2/28

(52) U.S. Cl. CPC B60N 2/2869; B60N 2/2806; B60N 2/2821

(57) ABSTRACT

A rotatable car seat is disclosed. The rotatable car seat includes a seat having an inner rotation disc positioned on a bottom surface of the seat, and a base having an outer rotation ring positioned on a top surface of the base, the inner rotation disc being rotatably fixed to the outer rotation ring. The base includes a belt lockoff positioned to pivotally engage a portion of a vehicle seat belt and define a tortuous path for the portion of the vehicle seat belt when in a closed position.

### CROSS-REFERENCE TO RELATED APPLICATION

This application claims the benefit under 35 U.S.C. § 119(e) of U.S. Provisional Patent Application No. 63/721,165 titled ROTATIONAL CAR SEAT filed on Nov. 15, 2024 and U.S. Provisional Patent Application No. 63/892,292 titled ROTATIONAL CAR SEAT filed on Oct. 2, 2025, each of which is herein incorporated by reference in its entirety for all purposes.

### FIELD OF TECHNOLOGY

The disclosure relates to car seats for infants and toddlers. Car seats typically secure a child safely in place in an automobile. Car seats may be designed to be rear facing or forward facing. The disclosure relates to rotatable car seats that may be arranged at least in a rear facing position and in a forward facing position.

### SUMMARY

In accordance with one aspect, there is provided a rotatable car seat. The rotatable car seat may comprise a seat having an inner rotation disc positioned on a bottom surface of the seat. The rotatable car seat may comprise a base having an outer rotation ring positioned on a top surface of the base. The inner rotation disc may be rotatably fixed to the outer rotation ring.

In some embodiments, an inner groove of the outer rotation ring overlaps a lip of the outer rotation disc.

In some embodiments, the rotatable car seat further comprises a vertical bushing positioned between the inner rotation disc and the outer rotation ring.

In some embodiments, a portion of the vertical bushing interlocks with one or more opening on a top surface of the outer rotation ring.

In some embodiments, the base comprises a recline shuttle and the outer rotation ring is positioned on a top surface of the recline shuttle.

In some embodiments, the rotatable car seat further comprises one or more protruding rings on the top surface of the recline shuttle positioned within a circumference of the outer rotation ring.

In accordance with another aspect, there is provided a rotatable car seat comprising a seat rotatably fixed to a base. The base may comprise a belt lockoff positioned to pivotally engage a portion of a vehicle seat belt and define a tortuous path for the portion of the vehicle seat belt when in a closed position.

In some embodiments, the belt lockoff is positioned within a lockoff pocket of the base.

According to at least one aspect of the present invention, a base for a rotatable car seat is presented, comprising a belt lockoff; a belt retainer; and a mechanical linkage coupling the belt lockoff to the belt retainer.

In some examples, the mechanical linkage includes a left component and a right component and the mechanical linkage is coupled to a lower section of the belt retainer. In some examples, the belt lockoff has a locked position and a raised position, the locked position corresponding to a position where the belt lockoff is lowered and the raised position corresponding to a position where the belt lockoff is raised relative to the locked position. In some examples, the belt retainer has an upper section, a lower section, and a slot between the upper and lower section, the slot being configured to receive a belt. In some examples, the base further comprises a belt lockoff handle coupled to the belt lockoff and configured to lock to a back surface of the base, the belt lockoff handle being configured to be raised to release the belt lockoff into a raised position. In some examples, the base further comprises one or more rings configured to be coupled to a seat, the seat being rotatable when coupled to the one or more rings. In some examples, the belt retainer is rotatably coupled to a bottom surface of the base, the linkage is rotatably coupled to the belt retainer, and the belt lockoff is rotatably coupled to the linkage and to a back surface of the base. In some examples, a belt lockoff handle is located below the belt lockoff and above the belt retainer. In some examples, the base further comprises a belt path, the belt path having two elements, a first element on a left side of a bottom surface of the base, and a second element on a right side of the bottom surface. In some examples, each element of the belt path has a single prong configured to retain a belt. In some examples, the base further comprises an over-center locking mechanism configured to bias the belt lockoff into a raised position or into a locked position based on a position of the belt lockoff relative to a critical position between the raised position and the locked position.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment.

The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1A is a perspective view of a car seat in a rear facing position, according to one embodiment;

FIG. 1B is a perspective view of a car seat in a forward facing position, according to one embodiment;

FIG. 2 is a perspective view of a car seat, according to one embodiment;

FIG. 3 is a side sectional view of a car seat, according to one embodiment;

FIG. 4A is a perspective view of a partial car seat, according to one embodiment;

FIG. 4B is a perspective view of a partial car seat, according to one embodiment;

FIG. 4C is a top sectional view of a partial car seat, according to one embodiment;

FIG. 5A is a front view of a base, according to one embodiment;

FIG. 5B is a side view of a base, according to one embodiment;

FIG. 5C is a top view of a base, according to one embodiment;

FIG. 5D is a side perspective view of a base, according to one embodiment;

FIG. 6A is a front view of a seat, according to one embodiment;

FIG. 6B is a side view of a seat, according to one embodiment;

FIG. 6C is a top view of a seat, according to one embodiment;

FIG. 6D is a side perspective view of a seat, according to one embodiment;

FIG. 7 is a perspective sectional view of a partial car seat, according to one embodiment;

FIG. 8 is a side sectional view of a partial car seat, according to one embodiment;

FIG. 9A is a side perspective view of a partial base, according to one embodiment;

FIG. 9B is a side perspective view of a recline shuttle, according to one embodiment;

FIG. 9C is a bottom perspective view of a recline shuttle, according to one embodiment;

FIG. 10A illustrates a perspective view of a base according to an embodiment;

FIG. 10B illustrates a perspective view of a base according to an embodiment;

FIG. 10C illustrates a perspective view of a base according to an embodiment;

FIG. 10D illustrates a perspective view of a base according to an embodiment;

FIG. 10E illustrates a cutaway view of a base according to an embodiment;

FIG. 11A illustrates a side-view of a locking mechanism according to an embodiment; and

FIG. 11B illustrates a side-view of a locking mechanism according to an embodiment.

### DETAILED DESCRIPTION

Car seats are special seats designed to secure infants and toddlers when being transported in an automobile or other vehicle. It is generally recommended that infants and smaller toddlers ride in rear facing car seats until they reach a weight or height limit allowed by the design of the car seat. The toddlers are then upgraded to a forward facing car seat until they outgrow the car seat altogether. There is a need for rotatable car seats that may be arranged in multiple positions, including a rear facing position and a forward facing position and reclined.

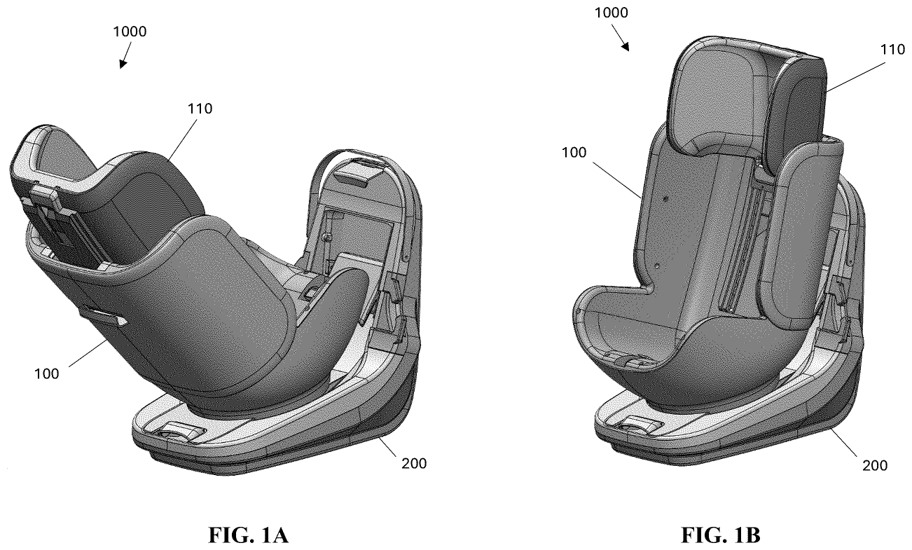

Turning to the figures, FIGS. 1A-1B show a rotatable car seat 1000 according to one embodiment. The rotatable car seat 1000 includes a seat 100 and a base 200. The seat 100 may be rotated into a rear facing position, as shown in FIG. 1A or into a forward facing position, as shown in FIG. 1B. In the rear facing position, a child in the car seat 1000 will face the rear of the vehicle. In the forward facing position, a child in the car seat 1000 will face the front of the vehicle. The rotatable car seat 1000 may be rotated into other positions, including left or right facing positions. Moving the rotatable car seat 1000 into a left or right facing position may assist in placing or removing a child from the seat. The base 200 may be secured to the seat of the automobile. The base 200 may generally remain static and secure during rotation of the seat 100.

In the figures, the seat 100 is shown without padding or inserts for clarity. However, it should be understood, that the seat may include one or more layers of padding, optionally removable and/or replaceable layers of padding, to accommodate the infant or toddler. Furthermore, the seat 100 may include one or more straps and/or buckles to secure the infant or toddler to the car seat.

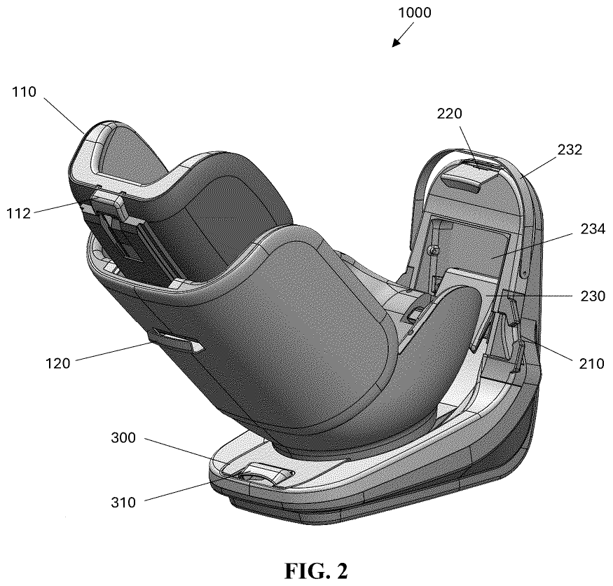

As shown in FIG. 2, the rotatable car seat 1000 may include a headrest 110. The headrest 110 may have an adjustable height to accommodate growing children. The height of the headrest 110 may be adjusted by toggling a headrest adjust handle 112 that enables the headrest 110 to travel up and down a track in the seat 100. Releasing the headrest adjust handle 112 may lock the headrest 110 into a desired height.

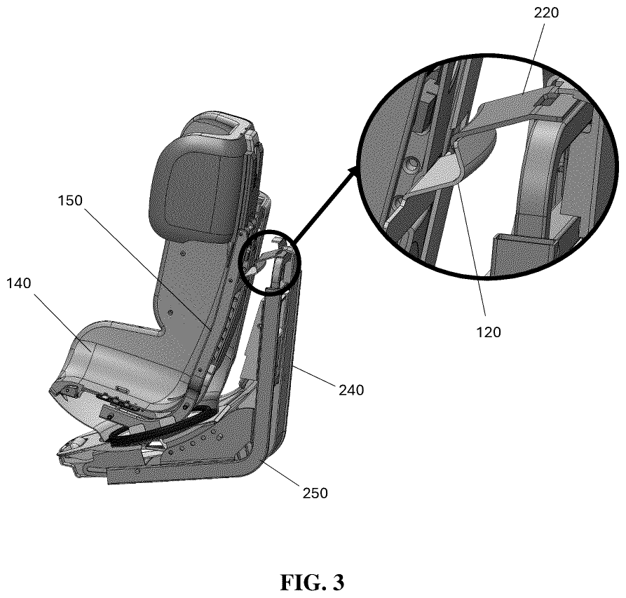

The rotatable car seat 1000 may include a forward facing hook 120 dimensioned to mate with a corresponding forward facing hook 220 on the base when the seat 100 is rotated into the forward facing position, as shown in FIG. 3. The corresponding hooks 120, 220 may be designed to secure the seat 100 in the forward position. In some embodiments, as shown in the exemplary embodiment of FIG. 3, the seat hook 120 may be an upward facing hook while the base hook 220 may be a downward facing hook. In other embodiments, the direction of the hooks may be reversed. The hooks 120, 220 may be curved, as shown in the enlarged portion of FIG. 3, to facilitate engagement when the seat 100 is rotated.

The base 200 may include a belt path 210. The automobile seat belt may be placed in the belt path 210 to secure the base 200 to the automobile seat. The base 200 may include a belt lockoff 230 to secure the seat belt to the belt path 210. The belt lockoff 230 may be positioned on a back surface of the base 200, optionally within a lockoff pocket 234 as shown in FIG. 2. The belt lockoff 230 may be pivotally fixed to the base. The lockoff pocket 234 may be formed by an indentation on the base adjacent the belt path 210. The exemplary belt lockoff 230 shown in FIG. 2 has a pivot point above the belt path 210 and is designed to pivot downward onto the seat belt. In other embodiments, the belt lockoff 230 may have a pivot point below the belt path 210 and be designed to pivot upward onto the seat belt. In some embodiments, the car seat 1000 may include a belt lockoff indicator. The belt lockoff indicator may identify when the belt lockoff 230 is in a closed and secure position by visual, auditory, and/or tactile representation.

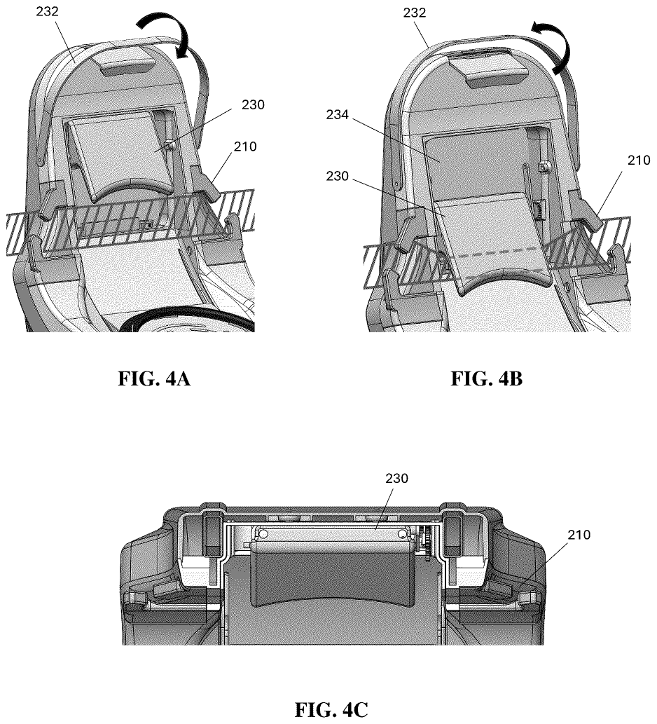

In use, the seat belt may be placed within the belt path 210 with the lockoff 230 in an open position (FIG. 4A). Excess slack of the seat belt may be removed. The lockoff 230 may then be toggled to a closed position to secure the seat belt in the belt path 210 (FIG. 4B). The base may include a lockoff handle 232 that actuates the belt lockoff 230 to secure the seat belt. The lockoff handle 232 may be mechanically connected to the lockoff 230 by gears, rack and pinion, or any other actuation mechanism. The exemplary lockoff handle 232 of FIGS. 4A-4B is positioned at a top end of the base 200. However, the lockoff handle 232 may be positioned anywhere along the base 200, including on a side or on the front of the base 200. When the belt lockoff 230 is in the closed position with the automobile seat belt within the belt path 210, the base is secured to the automobile seat.

In some embodiments, the belt lockoff 230 may be designed, for example, dimensioned, to create a tortuous path for the seat belt when closed, as shown in the exemplary embodiment of FIG. 4C, which is a partial top view of the base 200. For instance, the belt lockoff 230 may be designed to pull a portion of the seat belt toward the base 200, and optionally within the lockoff pocket 234 positioned on a back surface of the base 200 adjacent the belt path 210. When the portion of the seat belt is pulled into the tortuous path formed by the lockoff 230, any remaining slack of the seat belt is removed and the belt is locked, preventing movement. Thus, in some embodiments, the lockoff 230 may have one or more wedges or other structural features on an interior surface designed to form the tortuous path. In some embodiments, the tortuous path may be formed by positioning the lockoff 230 to pull the seat belt into the lockoff pocket 234 when closed.

The seat 100 may include a seat shell 140 and a seat frame 150, as shown in the sectional view of FIG. 3. The seat frame 150 may provide structural support for the seat 100. Additionally, the seat frame 150 may be fixed to a recline mechanism and optionally to a rotation mechanism. The seat frame 150 may be formed of a structural metal. The seat shell 140 may be formed of a polymer or other material. The base 200 may include a base shell 240 and a base frame 250. The base frame 250 may provide structural support for the base 200. The base frame 250 may be formed of a structural metal while the base shell 240 may be formed of a polymer or other material. The base frame 250 may comprise locking elements that engage with corresponding locking elements on the seat frame 150 to lock the seat 100 into a desired reclined and/or rotated position.

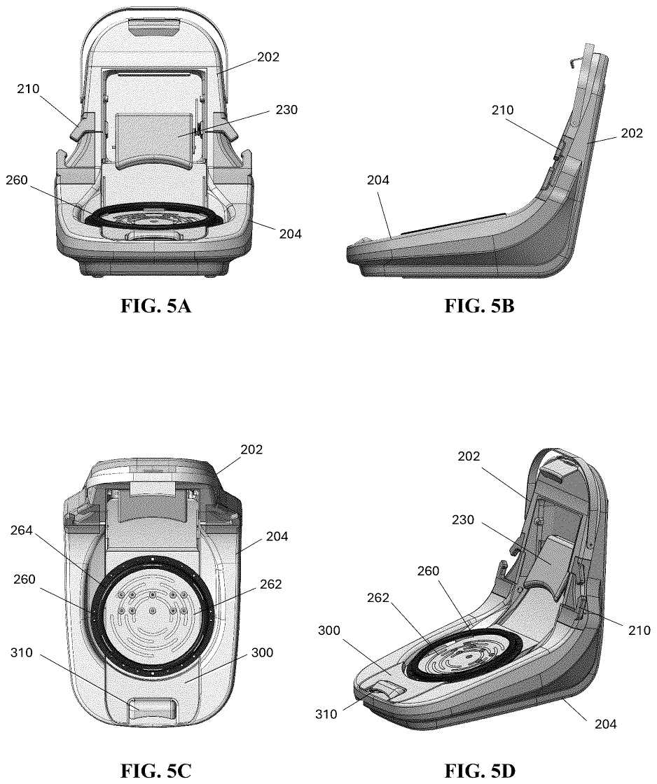

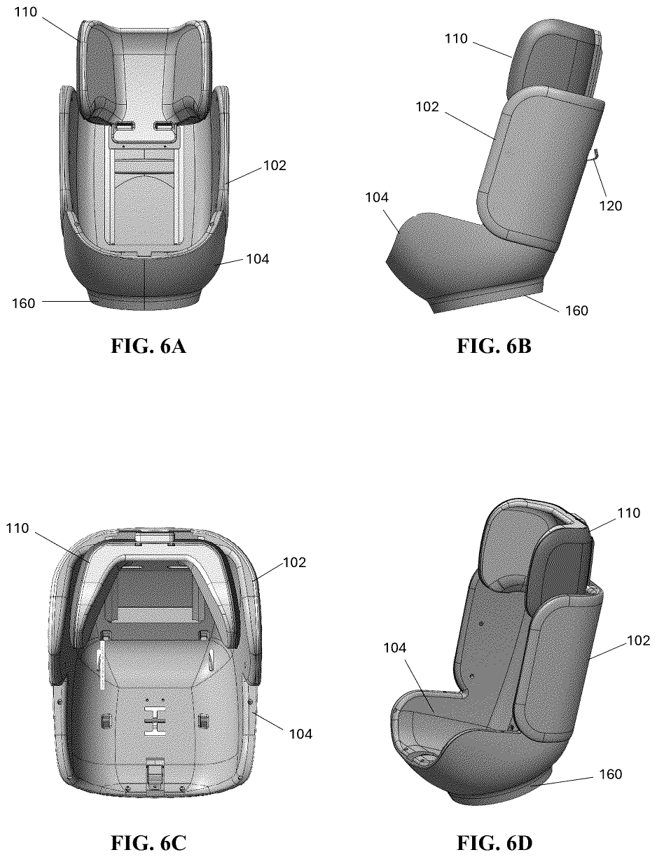

The seat 100 may be rotatably fixed to the base 200. In certain embodiments, the seat 100 is not removable from the base 200. As shown in FIGS. 5A-5D, the base 200 may comprise a back surface 202 and a bottom surface 204. The back surface 202 may be configured to be positioned against a seat back portion of the vehicle seat. The bottom surface 204 may be configured to be positioned on a seat surface portion of the vehicle seat. As shown in FIGS. 6A-6D, the seat may comprise a seat back 102 and a seat surface 104. The seat surface 104 may be rotatably fixed to the bottom surface 204 of the base 200.

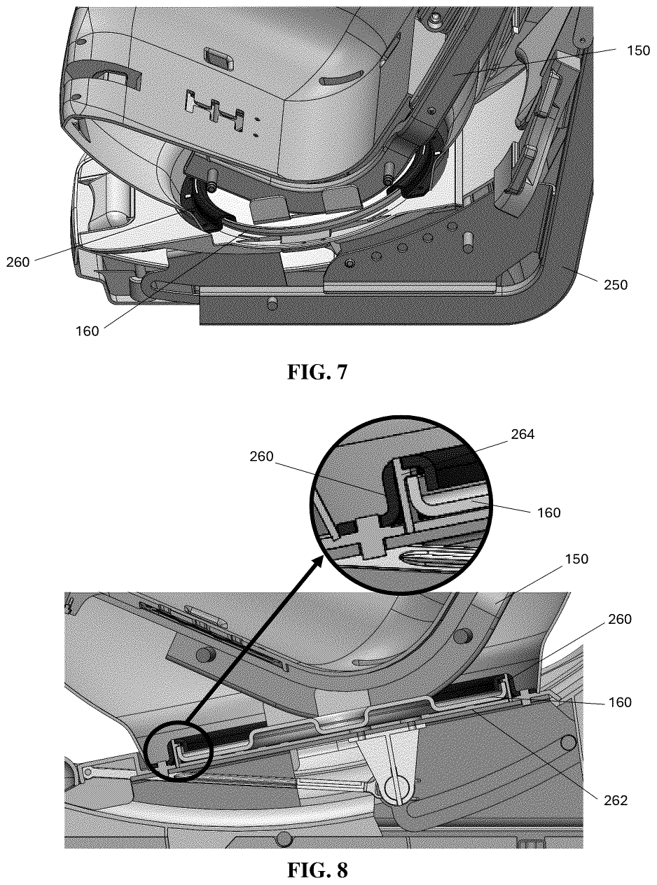

The rotation mechanism between the seat 100 and the base 200 may be formed by interlocking rings, as shown in the sectional view of FIGS. 7-8. The rotation mechanism may allow for 360° rotation of the seat 100. An outer rotation ring 260 positioned on a top side of the bottom surface of the base 200 may rotatably interlock with an inner rotation disc 160 positioned on a bottom side of the seat surface 104. The outer rotation ring 260 may be fixed to the recline shuttle 300 (FIG. 5C). The inner rotation disc 160 may be fixed to the seat frame 150. In the exemplary embodiment shown in the enlarged view of FIG. 8, an inner groove of the outer rotation ring 260 overlaps a lip of the outer rotation disc 160. A vertical bushing 264 may be positioned within the outer rotation ring 260 adjacent to the inner rotation disc 160. A portion of the vertical bushing 264 may interlock with the outer rotation ring 260 by extending through one or more openings on the top surface of the outer rotation ring 260, as shown in FIG. 5C.

The outer rotation ring 260, inner rotation disc 160, and vertical bushing 264 may be formed of complementary materials that reduce friction and/or improve tolerance during rotation. For instance, the materials of the outer rotation ring 260, inner rotation disc 160, and vertical bushing 264 may each be selected to avoid metal on metal friction. In some embodiments, the outer rotation ring 260 may be formed of a polymer material and the inner rotation disc 160 may be formed of a metal material. In other embodiments, the outer rotation ring 260 may be formed of a metal material and the inner rotation disc 160 may be formed of a polymer material. In yet other embodiments, the outer rotation ring 260 and the inner rotation disc 160 may both be formed of metal or a polymer material. The vertical bushings 264 may be formed of a low friction material, such as a low friction polymer or metal material. The outer rotation ring 260 and inner rotation disc 160 may be formed of a single piece. In some embodiments, the outer rotation ring 260 and/or the inner rotation disc 160 may comprise perforations to reduce friction between the materials during rotation.

In some embodiments, the rotation mechanism may comprise one or more protruding rings 262 (FIGS. 5C-5D). The protruding rings 262 may be positioned within the circumference of the outer rotation ring 260, as shown in the sectional view of FIG. 8. The protruding rings 262 may project from the base 200, for example, from the shuttle 300. When assembled, the protruding rings 262 may be positioned adjacent to the inner rotation disc 160. The protruding rings 262 may serve to reduce the surface area of the base 200 (e.g., of shuttle 300) that comes into contact with the inner rotation disc 160 during rotation. The protruding rings 262 may be formed of a low friction material, such as a low friction polymer or metal material.

In some embodiments, the rotation mechanism may have a lockoff. The lockoff may be used to lock the seat 100 in the rear facing position or in the forward facing position (at 180° of rotation). In some embodiments, the lockoff may be used to lock the seat 100 at an intermediate position, such as a left facing or right facing position, or about 90° from either the rear facing or forward facing positions. The intermediate position may be used to load or unload a child from the car seat 1000. The lockoff may be formed by one or more holes or openings along the inner rotation disc 160 that align at the predetermined positions (e.g., 0°, 90°, 180°, or 270°) to receive one or more pins. The one or more pins may be retractably fixed to the outer rotation ring 260. When aligned, the one or more pins may lock into the corresponding one or more holes to lock rotation of the seat 100.

The car seat 1000 may comprise a rotation lockoff release mechanism mechanically connected to the one or more pins. The rotation lockoff release mechanism may be actuated to retract the one or more pins and release the lock. In some embodiments, the car seat 1000 comprises a handle that actuates the lockoff release mechanism. The handle may be positioned at any location, for example, on a side, front, or top of the base 200 or seat 100. In some embodiments, the rotation lockoff comprises an indicator. The rotation lockoff indicator may identify when the rotation lockoff is engaged (in a locked position) by visual, auditory, and/or tactile representation.

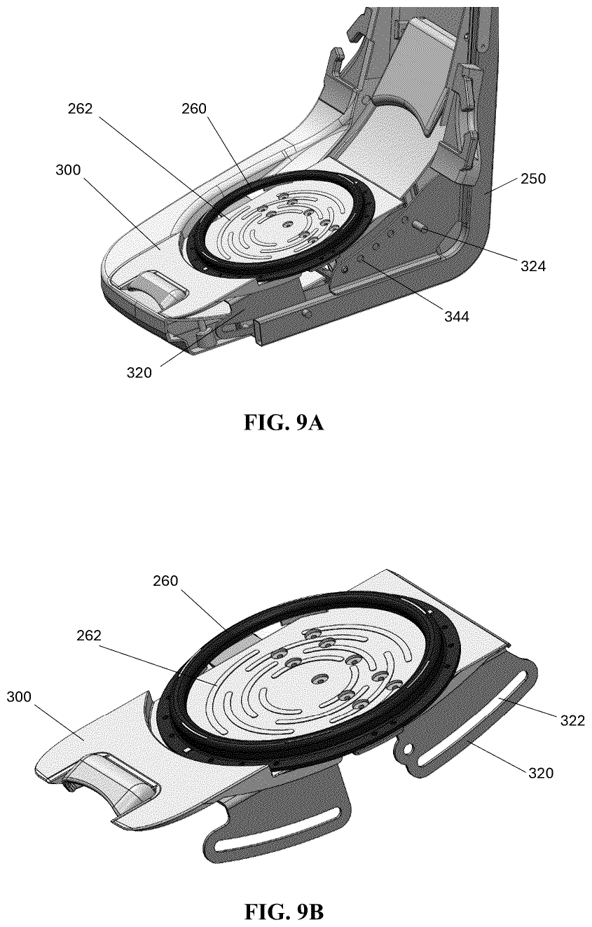

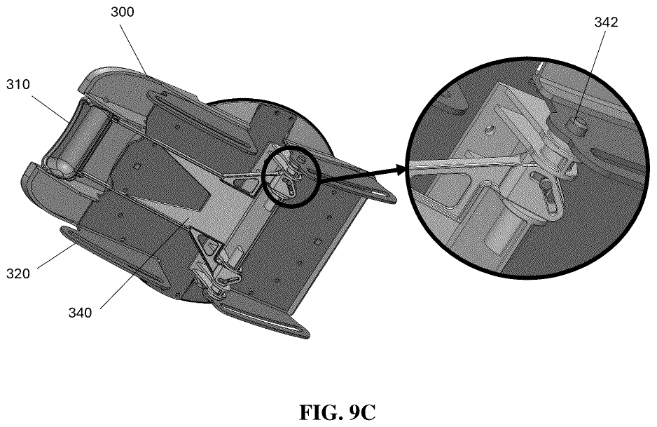

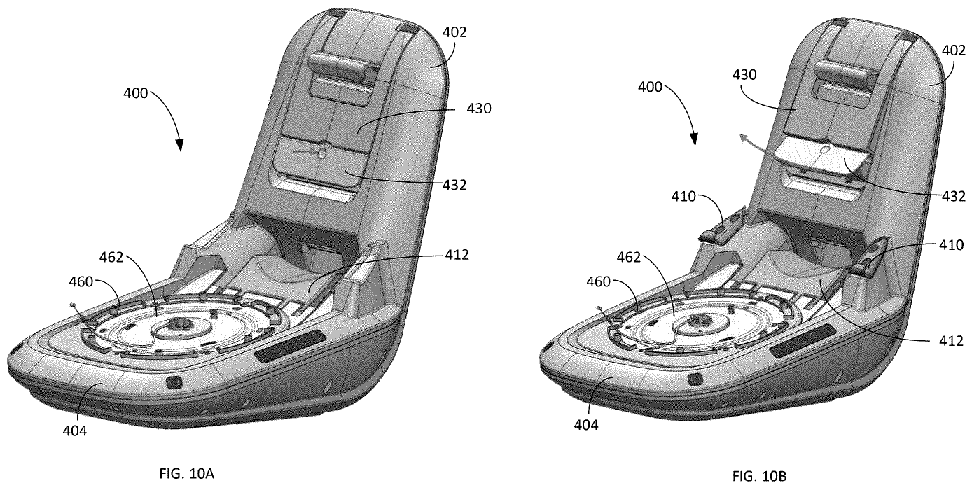

In certain embodiments, the seat 100 may be configured to recline. The seat 100 may comprise a recline mechanism. The recline mechanism may comprise a recline shuttle 300 (FIGS. 9A-9C) positioned on the base 200. The seat 100, and the rotation mechanism, may be fixed to the recline shuttle 300. The recline shuttle 300 may tilt the seat 100 into one or more recline angles. In some embodiments, the recline shuttle 300 includes one or more carriages 320 positioned on a bottom surface. The exemplary embodiment of FIGS. 9A-9C includes two carriages 320 positioned at opposite ends of the shuttle 300 (FIG. 9C). Each carriage 320 may comprise one or more elongated slots or tracks 322 that define the recline path. The base 200 may comprise cross rods 324 extending between opposite sides of the base frame 250 through the slots or tracks 322. In use, the cross rods 324 may run along the length of the slots or tracks 322 of the carriage 320 as the shuttle 300 tilts to recline the seat 100. The recline shuttle 300 and one or more carriages 320 may each be formed of a metal or polymer material.

The recline mechanism may comprise a recline lockoff (340, 342) capable of locking the recline mechanism into one of the several recline angles. The recline lockoff may comprise a recline whip 340 positioned on a bottom side of the shuttle 300 (FIG. 9C). The recline whip 340 may be mechanically coupled to retractable locking pins 342 that lock into one or more position holes 344 on the base frame 250, locking the shuttle 300 into a recline angle. The base frame 250 may comprise a number of position holes 344 selected to define a number of available recline angles for the seat 100.

The recline lockoff may comprise a recline release handle 310 mechanically coupled to pull the recline whip 340, which in turn retracts the locking pins 342. In the exemplary embodiment of FIG. 2, the recline release handle 310 is positioned on a front of the base 200, specifically on a front of the recline shuttle 300. However, the recline release handle 310 may be positioned anywhere on the base 200, for example, on a top, side, or front of the base 200. Actuating the recline release handle 310 may pull the whip 340 to retract the locking pins 342 from position holes 344, allowing the shuttle 300 and seat 100 to move along the recline path defined by the slots or tracks 322 of the carriage 320. Releasing the recline release handle 310 may lock the shuttle 300 into a fixed position by releasing the whip 340 to extend the locking pins 342 into position holes 344.

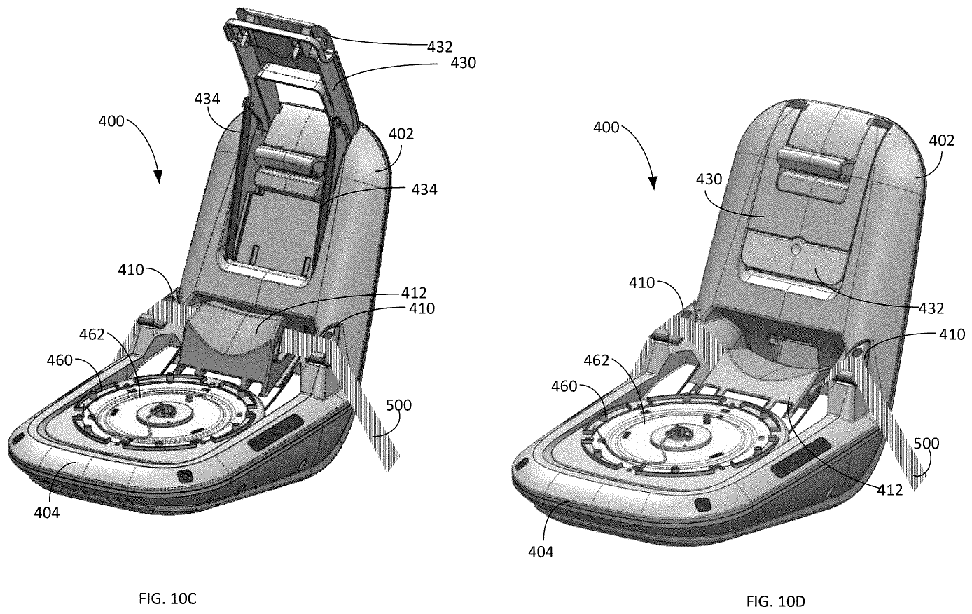

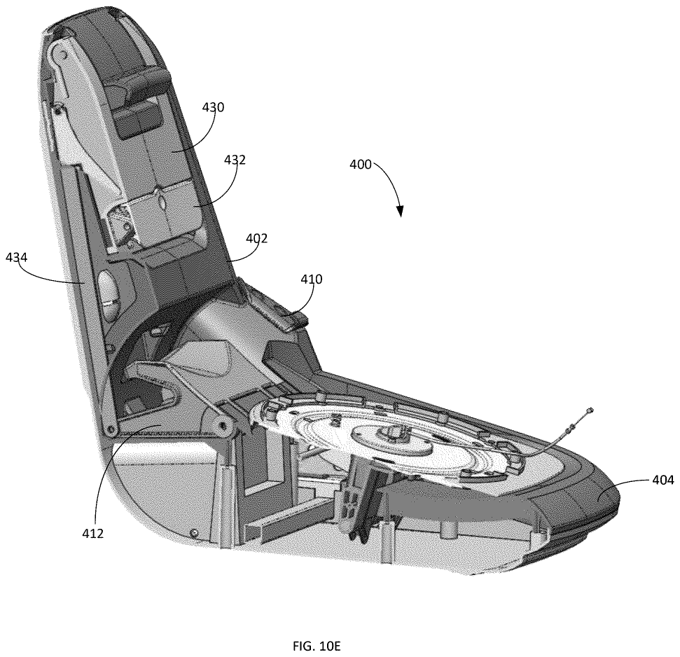

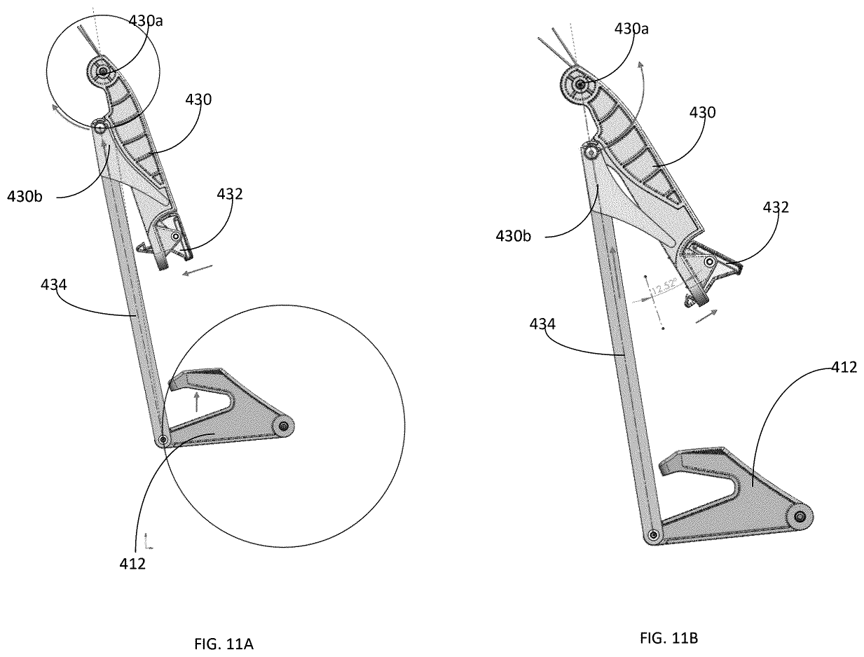

FIGS. 10A and 10B illustrate a base 400 according to an example. The base 400 is similar to the base 200 in some ways, but differs in other ways.

The base 400 includes back surface 402, a bottom surface 404, one or more belt paths 410 (“belt path 410”), a belt retainer 412, a belt lockoff 430, a belt lockoff handle 432, an outer rotation ring 460, one or more protruding rings 462, and any features of the base 200 that are desired.

The back surface 402 forms the back of the base 400 and may be coupled to the bottom surface 404, and to the belt lockoff 430 and belt lockoff handle 432, and may be coupled to the belt path 410. The bottom surface 404 may be coupled to the back surface 402, the outer rotation ring 460, the one or more protruding rings 462, the belt retainer 412, and may be coupled to the belt path 410.

The belt lockoff handle 432 locks the belt lockoff 430 in place. The belt lockoff handle 432 may be pulled (e.g., raised) to release the belt lockoff 430, at which point the belt lockoff 430 may be raised. Raising the belt lockoff 430 causes the belt retainer 412 to rotate upward, thereby permitting a belt to be run through the belt path 410 and through a retaining slot of the belt retainer 412, as will be shown in greater detail with respect to FIGS. 10C and 10D, below. When the belt retainer 412 is in the lower position and the belt lockoff 430 is in the locked position (in some examples, corresponding to when the belt lockoff handle 432 is flush with the back surface 402), a belt, such as a seat belt, will be locked in place and firmly secured to the base 400.

The outer rotation ring 460 and one or more protruding rings 462 may support a seat and may permit the seat to rotate up to 360 degrees relative to a current position or facing of the seat.

FIGS. 10B and 10C illustrate the base 400 in a locked position (FIG. 10D) where the belt is locked in place, and in an unlocked position (FIG. 10C) where the belt is not locked in place.

FIG. 10C shows a linkage 434 with left and right side components on either side of the belt lockoff 430. One end of the linkage 434 is coupled to the belt lockoff 430, and the other end of the linkage 434 is coupled to the lower portion of the belt retainer 412. This is illustrated in greater detail in FIG. 10E.

As FIGS. 10C and 10D show, when the belt lockoff 430 is in the raised position, the linkage 434 pulls the bottom of the belt retainer 412 upward, which permits the belt 500 to be run through belt path 410 and through the slot in the belt retainer 412 across the base 400. As shown in FIG. 10D, when the belt lockoff 430 is in the locked position, the linkages 434 are hidden and push the belt retainer 412 down so that the belt 500 is locked in place by the belt retainer 412 when the belt retainer 412 pulls the belt 500 downward relative to the belt path 410.

FIG. 10E shows a cutaway view of the base 400 according to an example. FIG. 10E shows the connection of the linkage 434 to the belt retainer 412. As illustrated, the belt lockoff 430 is in the locked position, and so the linkages 434 are hidden and in their lower position, which means that the bottom of the belt retainer 412 is pushed down, thereby pushing the entire belt retainer 412 down into the locked position.

As can be seen in FIG. 10E, the belt retainer 412 has a lower section and an upper section, and a slot in the middle between the upper and lower sections. The slot, in this embodiment, is enclosed on up to three planes and open on three planes. The belt 500 may be placed in the slot when the belt retainer 412 is in the raised position, and in the locked position the back surface 402 creates a barrier on a fourth plane (such that four different planes are blocked, and two planes, located opposite each other, are not blocked). The belt 500 passes through the two unblocked planes but is otherwise trapped within the slot defined by the four closed planes. The belt retainer 412 is mounted on a pivot and the back surface 402 corresponding to the space the belt retainer 412 pivots through is curved to accommodate the motion of the belt retainer 412.

Note that, in some examples, the belt path 410 has a different form compared to the belt path 210. Specifically, each element of the belt path 410 has a single prong located at a lowest section of that element of the belt path 410, rather than having both upper and lower prongs and/or slots.

In some examples, the linkage 434 is rotatable relative to one or both of the belt retainer 412 and/or the belt lockoff 430.

In some examples, the belt retainer 412 is rotatable relative to the bottom surface 404 and/or is coupled to the bottom surface 404 via one or more pivots and/or axles.

In some examples, the base 400 is configured to have an over-center locking mechanism, wherein in the closed position tension and forces from the belt maintain the locked position until the belt lockoff 430 and/or belt lockoff handle 432 are moved past a critical position from the locked position and raised position. In some examples, in the raised position, springs hold the belt lockoff in the open position by exerting force opposing the movement of the belt lockoff into the locked position, at least until the belt lockoff 430 and/or belt lockoff handle 432 are moved past the critical position from the raised position to the locked position.

FIGS. 11A and 11B illustrate the operation of an embodiment of the over-center locking mechanism according to an example. The belt lockoff 430 has a pivot 430a and a sliding element 430b. The pivot 430a is the point around which the belt lockoff 430 rotates, and the sliding element 430b is coupled to a second pivot at a first end of the linkage 434 (opposite the second end of the linkage 434, where the linkage 434 is connected by a second pivot to the belt retainer 412). The belt lockoff 430 is configured to receive an arm that extends away from the first pivot with a mating feature that is the complement of the arm portion of the sliding element 430b.

This over-center mechanism may work as follows: in the locked position (shown in FIG. 11A), the axis described by the line between the second pivot of the linkage 434 and the pivot 430a is not the same as the longitudinal axis of the linkage 434 (e.g., as described by a line between the first and second pivots of the linkage 434). The belt 500 applies upward force on the belt retainer 412 in this locked position, which would push the sliding element 430b into the complementary receptacle on the belt lockoff 430. Because the first and second axis described above are offset, the torque applied by the belt 500 (through the linkage 434), as shown in FIG. 11A, clockwise relative to the point-of-view of the figure. Thus, the belt lockoff 430 is biased into the back of the seat.

By contrast, in the raised (e.g., open or unlocked) position, the two axes are offset in the opposite direction, and thus the torque applied by the belt 500 (through the linkage 434) is counter-clockwise with respect to the point-of-view of FIG. 11B. In this case, the belt lockoff 430 is now biased into the raised position instead of into the back of the seat.

As a result, it is only when the two axes pass the point wherein they are aligned that the system will switch from clockwise (or counterclockwise) torque and bias to the opposite direction of counterclockwise (or clockwise).

In some embodiments, the recline mechanism may be locked when the seat 100 is in the forward facing position. The corresponding base and seat hooks 220, 120 may be positioned to engage in the forward facing position, securing the seat 100. In the forward facing position, the recline mechanism may be locked at an angle that allows engagement of the corresponding hooks 220, 120. Additionally, in certain embodiments, the rotation mechanism may block rotation of the seat 100 into the forward facing position when the seat 100 is reclined into any recline angle that does not allow engagement of the corresponding hooks 220, 120. Thus, in certain embodiments, the rotation mechanism may only allow rotation of the seat 100 into the forward facing position when the seat 100 is reclined to a specific recline angle. For instance, the rotation mechanism may include spring loaded tabs or any other mechanism that blocks rotation of the seat 100 into the forward facing position when the seat 100 is reclined to any incorrect recline angle.

The disclosure is not limited in its application to the details of construction and the arrangement of components set forth in the following description or illustrated in the drawings. The disclosure is capable of other examples and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional terms.

Having thus described several aspects of at least one embodiment of this disclosure, it is to be appreciated that various alterations, modifications, and improvements will readily occur to those skilled in the art. Such alterations, modifications, and improvements are intended to be part of this disclosure and are intended to be within the spirit and scope of the disclosure. Accordingly, the foregoing description and drawings are by way of example only.

What is claimed is:

1. A rotatable car seat comprising:
a seat having an inner rotation disc positioned on a bottom surface of the seat; and
a base having an outer rotation ring positioned on a top surface of the base,
the inner rotation disc being rotatably fixed to the outer rotation ring.

2. The rotatable car seat of claim 1, wherein an inner groove of the outer rotation ring overlaps a lip of the outer rotation disc.

3. The rotatable car seat of claim 1, further comprising a vertical bushing positioned between the inner rotation disc and the outer rotation ring.

4. The rotatable car seat of claim 3, wherein a portion of the vertical bushing interlocks with one or more opening on a top surface of the outer rotation ring.

5. The rotatable car seat of claim 1, wherein the base comprises a recline shuttle and the outer rotation ring is positioned on a top surface of the recline shuttle.

6. The rotatable car seat of claim 5, further comprising one or more protruding rings on the top surface of the recline shuttle positioned within a circumference of the outer rotation ring.

7. A rotatable car seat comprising a seat rotatably fixed to a base, the base comprising a belt lockoff positioned to pivotally engage a portion of a vehicle seat belt and define a tortuous path for the portion of the vehicle seat belt when in a closed position.

8. The rotatable car seat of claim 7, wherein the belt lockoff is positioned within a lockoff pocket of the base.

9. A base for a rotatable car seat, comprising:
a belt lockoff;
a belt retainer; and
a mechanical linkage coupling the belt lockoff to the belt retainer.

10. The base of claim 9 wherein the mechanical linkage includes a left component and a right component and the mechanical linkage is coupled to a lower section of the belt retainer.

11. The base of claim 9 wherein the belt lockoff has a locked position and a raised position, the locked position corresponding to a position where the belt lockoff is lowered and the raised position corresponding to a position where the belt lockoff is raised relative to the locked position.

12. The base of claim 9 wherein the belt retainer has an upper section, a lower section, and a slot between the upper and lower section, the slot being configured to receive a belt.

13. The base of claim 9 further comprising a belt lockoff handle coupled to the belt lockoff and configured to lock to a back surface of the base, the belt lockoff handle being configured to be raised to release the belt lockoff into a raised position.

14. The base of claim 9 further comprising one or more rings configured to be coupled to a seat, the seat being rotatable when coupled to the one or more rings.

15. The base of claim 9 wherein the belt retainer is rotatably coupled to a bottom surface of the base, the linkage is rotatably coupled to the belt retainer, and the belt lockoff is rotatably coupled to the linkage and to a back surface of the base.

16. The base of claim 9 wherein a belt lockoff handle is located below the belt lockoff and above the belt retainer.

17. The base of claim 9 further comprising a belt path, the belt path having two elements, a first element on a left side of a bottom surface of the base, and a second element on a right side of the bottom surface.

18. The base of claim 17 wherein each element of the belt path has a single prong configured to retain a belt.

19. The base of claim 9 further comprising an over-center locking mechanism configured to bias the belt lockoff into a raised position or into a locked position based on a position of the belt lockoff relative to a critical position between the raised position and the locked position.
